(19) United States
(12) Patent Application Publication
(10) Pub. No.: US 2026/0233483 A1
(43) Pub. Date: Aug. 13, 2026

(54) COMPRESSION MECHANISM

(71) Applicant: FUTURA S.P.A., Capannori (IT)

(72) Inventor: Fabio PERINI, Viareggio (IT)

(21) Appl. No.: 19/156,504

(22) PCT Filed: Apr. 8, 2024
(86) PCT No.: PCT/IT2024/050069

§ 371 Date: Aug. 14, 2025

(30) Foreign Application Priority Data
May 19, 2023 (IT) 102023000010200

(51) Int. Cl. B30B 3/04; B30B 15/16

(52) U.S. Cl. CPC B30B 3/04; B30B 15/16

(57) ABSTRACT

Compression system comprising two pressers (2, 3) mounted on a load-bearing frame (1), wherein—a presser is pushed towards the other presser by means of respective thrust means (5) generating a given thrust (L5),—an adjustable stop (60) fastened to the load-bearing frame (1) is opposed to the thrust means and is placed between the load-bearing frame and the thrust means to absorb a part (L6) of the thrust (L5) and unload it onto the frame, such that a second part (L23) of the thrust (L5) is transmitted to the two pressers,—the adjustable stop is connected to respective position adjustment means (6),—the thrust means comprise at least one first actuator cylinder supplied with a fluid at a pre-established pressure, the at least one first actuator cylinder having a known and predefined bore; and—the means for regulating the adjustable stop comprise at least one further actuator cylinder.

### DESCRIPTION

The present invention relates to a mechanical compression system with an integrated control mechanism.

More particularly, a control mechanism in accordance with the present invention is intended to be integrated into systems in which two pressers exert, in cooperation with each other, a given pressure on a body intended to be compressed. For example, a system of this type comprises a roller and a counter-roller that define a nip crossed by a web-like material, such as paper or non-woven fabric (TNT), which exert on such material a pressure provided by two actuators acting on two opposite sides of the roller. Generally, the pressure exerted by the pressers varies over time due to various factors such as, for example: the surface wear of one or both pressers; the variability of the mechanical characteristics of the surface coating of one or both pressers due to temperature variations related to a prolonged use of the pressers; the variability of the characteristics of the materials processed by the pressers, variability due both to environmental conditions and to the nature of the processed materials which do not always have constant physical characteristics.

Therefore, the operators responsible for the operation of the machines that use said compression systems must carry out adjustment operations which, however, are generally delayed because they are carried out after the checks executed on the processed materials for checking their compliance with pre-established production standards. This leads to higher production costs due to waste that is thus produced. US2023/0085467A1 discloses a rolling mill for the fragmentation of bulky material comprising a pair of pressing rollers connected to a synchronization device including two hydraulic actuators each acting on a respective floating bearing supporting one of the two pressers. The synchronization device is arranged behind the pressure roller on which it acts and is configured to adjust the relative position of the floating bearings of this roller so as to avoid or limit a loss of parallelism of the axes of the two pressure rollers.

The main aim of the present invention is to eliminate, or at least greatly reduce, the aforementioned drawbacks.

This result has been achieved, in accordance with the present invention, by adopting the idea of providing a control mechanism for mechanical compression systems having the features indicated in claim 1. Other features of the present invention are the subject of the dependent claims.

Thanks to the present invention, it is possible to ensure a more precise application of pressure on the treated materials and, therefore, to improve the quality of the processes that use it, to increase the compliance of the quality of the processed materials with the pre-established production standards and to reduce waste, all this with very low implementation costs in relation to the advantages that this control mechanism offers. These and further advantages and features of the present invention will be more and better understood by every person skilled in the art thanks to the following description and the attached drawings, provided by way of example but not to be considered in a limiting sense, in which:

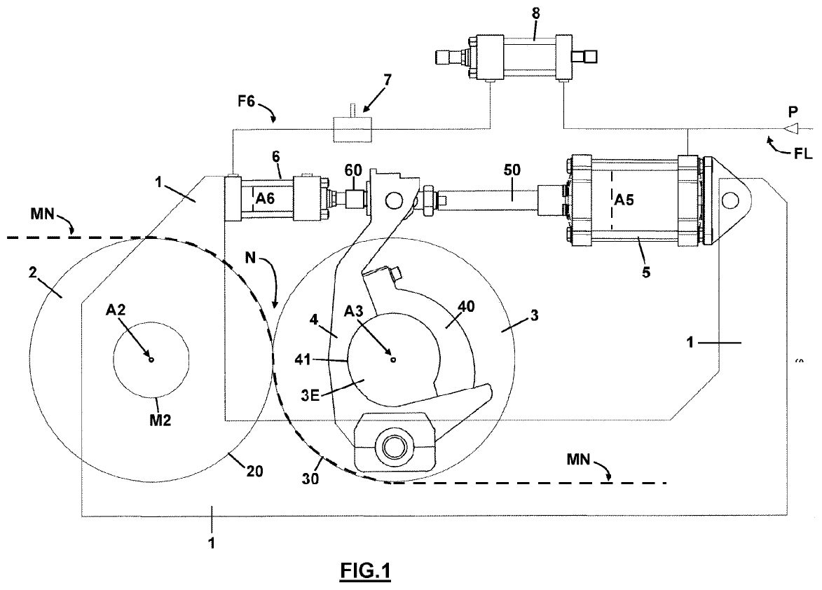

FIG. 1 is a schematic side view of a control mechanism for mechanical compression systems in accordance with the present invention applied to an embossing unit for the treatment of web-like materials such as paper or TNT;

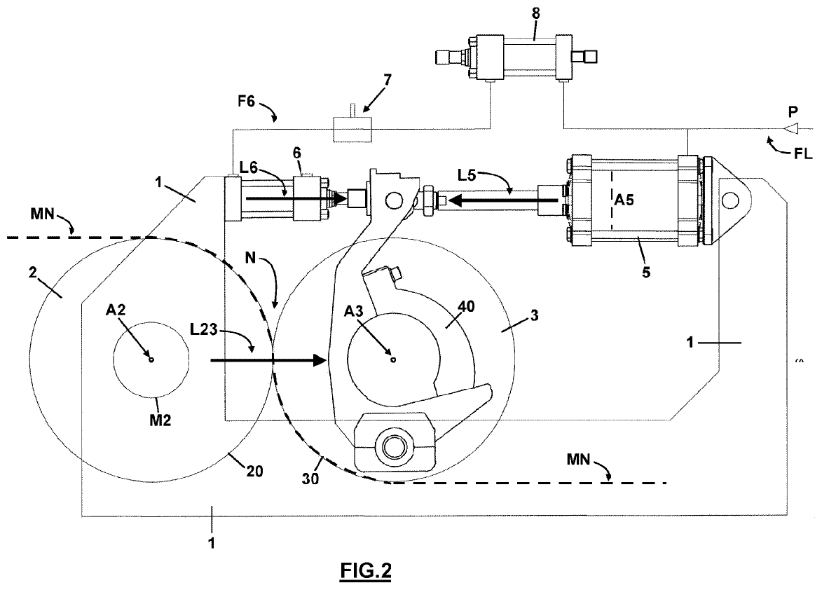

FIG. 2 is a view identical to that of FIG. 1 in which the forces L5, L23, L6 are represented.

The following detailed description refers to a possible example of realization of an embossing unit for the treatment of web-like materials such as tissue paper which uses a control mechanism in accordance with the present invention.

FIG. 1 shows an embossing unit (UG) for web-like materials comprising a load-bearing frame (1) on which a steel roller (2) is mounted, provided with incisions on its external surface (20), and a counter-roller (3) with external surface (30) covered with rubber, which define a nip (N) crossed by a web-like material (MN) subjected to embossing as a result of its passage through the nip (N). The roller (2) and the counter-roller (3) are arranged with their respective axes parallel to each other transversely to the frame (1). The roller (2) is rotated around its axis (A2), with a pre-established angular speed, by a respective driving unit (M2). The axis (A2) of roller (2) is fixed. On each of its sides, the counter-roller (3) is supported by a lever (4) connected to a respective thrust cylinder (5). In FIG. 1 a single lever (4) and a single thrust cylinder (5) are visible, as it is a side view of the lamination unit (U). Each lever (4) is locked at a respective end (3E) of the counter-roller (3) by means of a semi-collar (40) which, in cooperation with a concave surface (41) of the same lever, grips said end. The thrust cylinder (5) is integral with the frame (1).

Through the levers (4), said cylinders (5) push the counter-roller (3) towards the roller (2).

The thrust cylinders (5) are fed with a working fluid at a pre-established pressure (P) correlated to the thrust that the counter-roller (3) must exert on the roller (2) depending on the programmed processing. In FIG. 1 the supply of the working fluid to the cylinder (5) is represented by the arrow “FL”.

The stroke of the rod (50) of each cylinder (5) is limited by a respective adjustable stop (60).

Each stop (60) is constituted by the free end of the rod of a further cylinder (6), integral with the frame (1), arranged horizontally coaxial to the rod (50) of the thrust cylinder (5). The further cylinder (6) is provided to produce a thrust (L6) of predefined value. The function of said thrust (L6) is explained below.

For example, the further cylinder (6) is supplied with a fluid at the same pressure (P) as the thrust cylinder (5) and has a bore (A6) smaller than the bore (A5) of the thrust cylinder (5). Therefore, the thrust (L5) produced by the thrust cylinder (5) is greater than the thrust (L6) produced by the further cylinder (6).

It is understood that the further cylinder (6) can be fed with a corresponding fluid, different from that which feeds the thrust cylinder (5), at a pressure sufficient to produce the thrust (L6).

In operation, in conditions of symmetry of the acting forces, the thrust (L5) exerted by each cylinder (5) through the respective rod (50) is:

L5=½*L23+L6

where L23 is the load acting between the rollers (2) and (3) and is a known value, being it a pre-established process parameter.

It is noted, in this regard, that the load (L6) is an additional load, compared to the load (L23), which serves to stiffen the embossing unit in order to reduce the vibrations that are normally generated during the operation of the same unit.

Each stop (6), counteracting the advancement of the rod (50) of the respective cylinder (5), releases the force (L6) on the frame (1).

Since the forces (L5) and (L6) do not vary, as they are related to the constant pressure (P) and the invariable bore of the cylinders (5) and (6), the thrust (L23) is also constant, even if the surface characteristics of the pressure rollers (2, 3) should undergo variations (for example because the rubber covering of roller 3 wears or overheats so that its elastic and/or geometric characteristics vary). In this way, a self-regulated system is realized. In the event of an increase or decrease in pressure (P), the thrust (L23) will be automatically adjusted because it is defined by the difference between the thrust (L5) and the thrust (L6) which depend directly on the pressure (P) and on the invariable geometric characteristics (in particular, the bore) of the cylinders (5) and (6).

For example, the further cylinder (6) is fed through a hydraulic accumulator (8) which is fed with the same fluid that feeds the thrust cylinder (5) and, at its outlet, supplies a different fluid to the further cylinder (6) but at the same supply pressure (P) as the thrust cylinder (5). The presence of said accumulator (8) stabilizes, in a known way, the supply pressure of the further cylinder (6).

Preferably, a flow regulator (7) is inserted on the supply line (F6) of the further cylinder (6) whose function is to slow down the movement of the stop (60) and to hinder the return of the fluid from the further cylinder (6) to the accumulator (8) due to the effect of mechanical vibrations transmitted through the stops (60).

In a simplified configuration of a system in accordance with the present invention, said thrust means could include only one cylinder (5) and the number of cylinders (5) could in any case be different from that exemplified above, depending on the specific practical application of the system. Similarly, the adjustable stop device that absorbs part of the thrust generated by the pusher means could include a single adjustable stop or more than two adjustable stops configured as described above.

In the embodiment illustrated by way of example in FIG. 1 and FIG. 2, the load-bearing frame (1) has two opposite vertical sides and a horizontal side that connects the lower parts of the vertical sides, forming a cradle where the roller (2) and the counter-roller (3) are positioned. The thrust cylinders (5) are mounted on one vertical side of the load-bearing frame (1) while the further cylinder (6) is mounted on the opposite vertical side.

More generally, the thrust cylinder (5) and the additional cylinder (6) can be mounted on two opposite parts of the load-bearing frame (1).

Therefore, in accordance with the present invention, a system is provided, comprising a first and a second presser (2, 3) which are mounted on a load-bearing frame (1) and have respective counter-faced compression surfaces (20, 30), wherein
one of the two pressers is pushed towards the other presser by means of respective thrust means (5) which are configured to generate a thrust (L5) of a pre-established value,
an adjustable stop device (60) connected to the load-bearing frame (1) is opposed to the thrust means (5) and is placed between the load-bearing frame (1) and the thrust means (5) to absorb a part (L6) of said thrust (L5) and unload it onto the frame (1), so that a second part (L23) of said thrust (L5) is transmitted to the two pressers,
the adjustable stop device (60) is connected to respective adjustment means (6) that adjust its position with respect to the thrust means (5),
the thrust means (5) comprise at least one first actuator cylinder supplied with a fluid at a pre-established pressure (P), said at least one first actuator cylinder having a known and predefined bore (A5); and
the means (6) for adjusting the adjustable stop comprise at least one further actuator cylinder.

A system in accordance with the present invention can also exhibit one or more of the following characteristics, even combined with each other:
said at least one further actuator cylinder is also supplied with a fluid at said pre-established pressure (P), said at least one further actuator cylinder having a bore (A6) smaller than the bore (A5) of the at least one first actuator cylinder;
the pressers (2, 3) are rollers parallel to each other and one of the two rollers is connected to a respective motor member (M2) which controls its rotation with a pre-established angular speed around its axis (A2);
the pressers (2, 3) are rollers parallel to each other, one of the two rollers is connected to a respective motor member (M2) which controls its rotation with a pre-established angular speed around its axis (A2), the external surface of one of the two rollers is engraved while the external surface of the other roller is smooth, preferably made of a rubber coating;
the pressers (2, 3) are rollers parallel to each other, one of the two rollers is connected to a respective motor member (M2) which controls its rotation with a pre-established angular speed around its axis (A2) and the external surface of both the rollers is smooth;
the pressers (2, 3) are rollers parallel to each other, both motorized, i.e. driven into rotation by the same motor or by two different motors; for example, both rollers are motorized and both have a smooth external surface, or both are motorized and one of them is engraved while the other is smooth, or both of the said rollers are engraved.
the further cylinder (6) is fed through a hydraulic accumulator (8) which is fed with the same fluid that feeds the at least one first actuator cylinder (5) and, at the outlet, supplies a different fluid to the at least one further cylinder (6) but at the same supply pressure (P) as said first actuator cylinder;
a flow regulator (7) is inserted on a supply line (F6) of the at least one further cylinder (6).

In practice, the execution details can however vary in an equivalent way as regards the individual elements described and illustrated, without departing from the idea of the solution adopted and therefore remaining within the limits of the protection granted by this patent in accordance with the following claims.

1) Mechanical compression system comprising a first and a second presser (2, 3) which are mounted on a load-bearing frame (1) and have respective counter-faced compression surfaces (20, 30), wherein
one of the two pressers is pushed towards the other presser by means of respective thrust means (5) which are configured to generate a thrust (L5) of a pre-established value,
an adjustable stop device (60) connected to the load-bearing frame (1) is opposed to the thrust means (5) and is placed between the load-bearing frame (1) and the thrust means (5) to absorb a part (L6) of said thrust (L5) and unloading it onto the frame (1), so that a second part (L23) of said thrust (L5) is transmitted to the two pressers,
the adjustable stop device (60) is connected to respective adjustment means (6) that adjust its position with respect to the thrust means (5),
the thrust means (5) comprise at least one first actuator cylinder supplied with a fluid at a pre-established pressure (P), said at least one first actuator cylinder having a known and predefined bore (A5); end
the means (6) for adjusting the adjustable stop comprise at least one further actuator cylinder.

2) Mechanical compression system according to claim 1 wherein said at least one further actuator cylinder is also supplied with a fluid at said pre-established pressure (P), said at least one further actuator cylinder having a bore (A6) smaller than the bore (A5) of the at least one first actuator cylinder.

3) Mechanical compression system according to claim 1 wherein the pressers (2, 3) are rollers parallel to each other and one of the two rollers is connected to a respective motor member (M2) which controls its rotation with a pre-established angular speed around its axis (A2).

4) Mechanical compression system according to claim 1 wherein the pressers (2, 3) are rollers parallel to each other, one of the two rollers is connected to a respective motor member (M2) which controls its rotation with a pre-established angular speed around its axis (A2), and the external surface of one of the two rollers is engraved while the external surface of the other roller is smooth, preferably made up of a rubber coating.

5) Mechanical compression system according to claim 1 wherein the pressers (2, 3) are rollers parallel to each other, one of the two rollers is connected to a respective motor member (M2) which controls its rotation with a pre-established angular speed around its axis (A2) and the outer surface of both rollers is smooth.

6) Mechanical compression system according to claim 1 wherein the pressers (2, 3) are rollers parallel to each other, both motorized.

7) Mechanical compression system according to claim 1 wherein the further cylinder (6) is fed through a hydraulic accumulator (8) which is fed with the same fluid that feeds the at least one first actuator cylinder and, at the outlet, supplies a different fluid to at least one further cylinder but at the same supply pressure (P) as said first actuator cylinder.

8) Mechanical compression system according to claim 1 wherein, on a supply line (F6) of at least one further cylinder, a flow regulator (7) is inserted.
